(19) United States
(12) Patent Application Publication
(10) Pub. No.: US 2017/0152690 A1
(43) Pub. Date: Jun. 1, 2017

(54) DOOR OR WINDOW HINGE

(71) Applicant: SIMONSWERK GmbH, Rheda-Wiedenbrueck (DE)

(72) Inventor: Jens KNOECHEL, Guetersloh (DE)

(21) Appl. No.: 15/360,654

(22) Filed: Nov. 23, 2016

(30) Foreign Application Priority Data
Nov. 26, 2015 (DE) 102015120555.6

(51) Int. Cl. E05D 11/00; E05D 11/06; F16H 19/04; E05D 3/02

(52) U.S. Cl. CPC E05D 11/00; E05D 11/0054; E05D 3/02; E05D 11/06; F16H 19/04; E05D 2011/0072

(57) ABSTRACT

A door or window hinge has a housing having a back wall facing in a predetermined direction and a side wall extending in the direction from the back wall. A rack fixed to the side wall and extending in the direction meshes with a sector gear fixed to an inner end of a hinge body and formed as a partial ellipse having a semimajor axis. The inner body end can rotate in the housing about an axis perpendicular to the direction and slides in the guide in the direction between a closed position with a stop face of the inner end bearing on the back wall and an open position with the inner end spaced in the direction from the back wall. The sector gear is oriented on the inner end such that in the closed position the semimajor axis extends substantially perpendicular to the direction.

### FIELD OF THE INVENTION

The present invention relates to a hinge. More particularly this invention concerns a concealed hinge adapted for carrying a door or window.

### BACKGROUND OF THE INVENTION

A hinge for doors or windows is known a housing and a hinge body rotatable about a hinge axis in the housing. This hinge axis is formed by structure that is displaceable in the housing along a guide track. The hinge body has an inner end provided with a sector gear that, during a pivot movement of the hinge body, rolls about its hinge axis between a closed position and an open position on a rack inside of the housing. The inner end of the hinge body has a stop face that in the closed position is positioned against a bottom face of a back wall of the housing.

When the door or window is closed, the hinge is hidden between the frame and door or window panel and is not visible from outside. One preferred field of use for the hinge is doors for residential and office spaces as well as building doors. The hinge may be used in doors that are flush or that have mortises and permit the door or window to be opened at least 100°. The opening movement is coupled with a straight-line movement of the hinge body. The result of the two movements is a rotational-sliding movement such that when a door hinge is pivoted, the door wing hinge is also displaced laterally relative to the door frame. This also applies when the hinge is used for windows or the like.

A hinge having the features described above is known from EP 1,400,646 and U.S. Pat. No. 2,078,815. The sector gear of the known arrangement is circularly arcuate. When a door equipped with the hinge is opened, the pivot movement of the door wing hinge also includes lateral displacement of the door wing, the rotational angle and the linear displacement having a constant relationship regardless of the angular position. The kinematics require considerable installation space and therefore may be improved. At the beginning of an opening movement from the closed position, the ratio of the rotational movement and the straight-line movement should be different than at the end of an opening movement. Another disadvantage of the known hinge may be found in that, when the hinge is in the closed condition, the moveable members of the hinge are also subject to forces acting on the door wing and the hinge closed condition is therefore relatively unstable.

### OBJECTS OF THE INVENTION

It is therefore an object of the present invention to provide an improved hinge.

Another object is the provision of such an improved hinge that overcomes the above-given disadvantages, in particular that, when the hinge is closed, stably absorbs high forces, and, during its opening movement, includes a linear and rotational movement such that the housing may be embodied with a narrower width.

### SUMMARY OF THE INVENTION

A door or window hinge has according to the invention a housing having a back wall facing in a predetermined direction and a side wall extending in the direction from the back wall. A guide in the housing extends in the direction. A hinge body has an inner end in the housing and an outer end extending from the housing. A rack fixed to the side wall and extending in the direction meshes with a sector gear fixed to the inner end and formed as a partial ellipse having a semimajor axis or a parabola having a symmetry plane. The inner end of the body is supported in the housing for rotation about an axis perpendicular to the direction and slidable in the guide in the direction such that the hinge body can pivot about the axis relative to the housing and also move in a straight line in the direction along the guide relative to the housing between an inner closed position with a stop face of the inner end bearing on the back wall and an open position with the inner end spaced in the direction from the back wall. The sector gear is oriented on the inner end such that in the closed position the semimajor axis or symmetry plane extends substantially perpendicular to the direction.

Thus according to the invention in the closed position the hinge body assumes a defined position, and high forces may be transmitted. Furthermore, as a result of the parabolic or part-elliptical shape of the sector gear, when the hinge body pivots out of the closed position, a straight-line movement is immediately executed, and first there is a significant rotational movement and as the rotational angle increases there is also progressively increasing straight-line displacement of the hinge axis. Due to the inventive kinematics, the joint arrangement within the housing takes up only little installation space. The door or window thus initially simply pivots out of its frame, and then is shifted further outward to allow it to be pivoted through a very large angle.

The rack is usefully arranged on a side wall of the housing that, in the installed condition, extends parallel to a door or window opening. “In the installed condition” means the arrangement of the hinge on a door or window.

In accordance with one preferred embodiment of the invention, the sector gear is formed of a noise-damping material, preferably plastic. Using a suitable material pairing between the material for the sector gear and the rack on the inside of the housing, it is possible to ensure lower wear and less noise when the hinge is opened and closed. The sector gear, preferably of plastic, may be connected as an exchangeable part to the hinge body in a positive fit. Alternatively, the sector gear may be securely joined to the hinge body using an adhesive bond or by vulcanizing. In principle, other bearing materials may also be used instead of plastic.

The housing preferably is of cast metal and the rack usefully is molded to the cast metal part to be unitary therewith.

Guide structure, in the form of a roller or sliding block linearly movably guided in a track or slot of the housing is usefully arranged at both an upper end face and a lower end face of the hinge body. The housing may have separate bearing inserts on each of which a guide track is provided. The separate inserts are usefully exchangeable in the housing. It is also within the scope of the invention that the bearing inserts are adjustable in the housing.

The geometric configuration of the hinge body influences the opening angle of the hinge. Between the inner end provided with the sector gear and a free projecting outer end, the hinge body has a bent curved center part that in the open position surrounds an upper edge of the housing. The hinge body is constructed such that the maximum opening angle of the hinge is at least 100° and preferably more than 100°.

The housing of the inventive hinge usefully has two side walls connected by top and bottom walls, forming a box open in the direction. The rack is on a first side wall and the second side wall preferably has an opening into which the bent curved middle part of the hinge body dips when the hinge body assumes its closed position. The described arrangement leads to a particularly compact design of the hinge and permits the installation space for the housing to be minimized.

### BRIEF DESCRIPTION OF THE DRAWING

The above and other objects, features, and advantages will become more readily apparent from the following description, reference being made to the accompanying drawing in which:

FIGS. 1A through 1D are sections through the inventive hinge in successive functional positions between a fully closed position (FIG. 1A) and a fully open position (FIG. 1D);

FIG. 2 is a perspective view of the hinge in the closed position of FIG. 1A;

FIG. 3 is a perspective view of the hinge housing of the hinge; and

FIGS. 4 and 5 are large-scale perspective views of hinges of the hinge according to the invention.

### SPECIFIC DESCRIPTION OF THE INVENTION

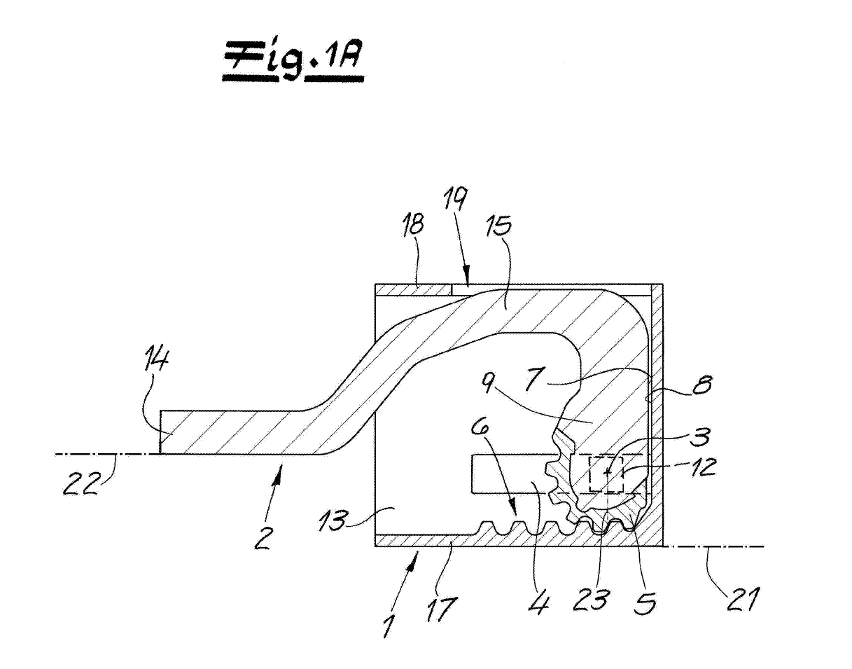

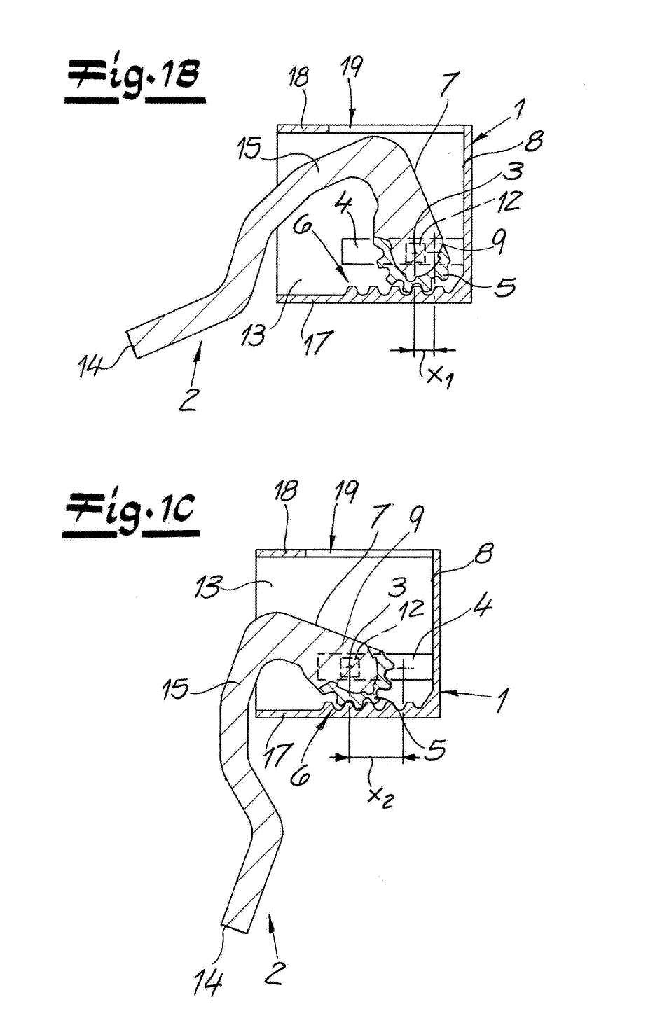

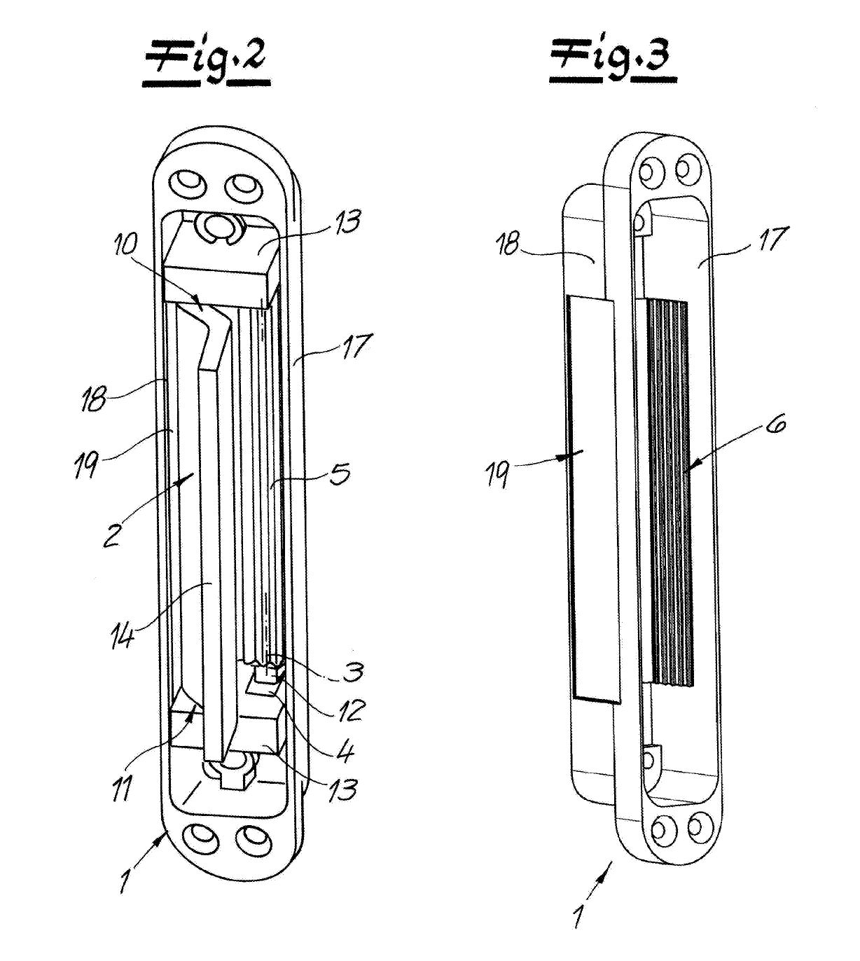

As seen in FIGS. 1A through 1D a hinge intended to be concealed when the door or window it is used with is closed comprises as a parallepipedal and box-like housing 1 and a largely metal hinge body 2 that is pivotal about a here vertical hinge axis 3 in the housing 1 typically seated in a door jamb shown schematically at 21. The hinge axis 3 is defined by an unillustrated cylindrical pivot shaft seated in a bore 20 (FIG. 4) of the hinge body 2 and having upper and lower ends 12 of square section and slidable in respective guide tracks or slots 4 formed in upper and lower plates 13 fixed in the housing 2. The hinge body 2 has an inner end 9 formed with an array of parallel radially outwardly directed teeth forming a sector gear 5 that, during a pivot movement of the hinge body 2, rotates about the hinge axis 3 to move the hinge between a closed position and a open position on a straight row of teeth forming a rack 6 on an inside face of a side wall 17 of the housing 1. The hinge body 2 also has an outer end 14 normally recessed in a door or window shown schematically at 22. The axis 3 could of course be horizontal or at any desired angular orientation with respect to the vertical

In the open position of FIG. 1D, the hinge assumes the maximum opening angle of at least 100°. FIGS. 1B and 1C show intermediate positions that are passed through during an opening or closing movement by the hinge. In FIG. 1B the opening angle is about 35° and in FIG. 1C the opening angle is about 70°. It may be seen by comparing FIGS. 1A through 1D that during such pivoting movement of the hinge body 2 about its hinge axis 3, there is a simultaneous straight-line or straight-line movement x of the hinge axis 3 along the guide track 4. The result of the two movements is a rotational-push movement, the hinge body 2 executing an outwardly oriented lateral movement relative to the housing 1 up to the opening angle of approximately 35° shown in FIG. 1B and then approaching the housing 1 with an increasing opening angle (FIGS. 1D and 1C). Due to these kinematics, the hinge is suitable especially for doors 11 with mortised and that close flush with the door frame 21.

The hinge body 2 has an end stop face 7 that in the closed position shown in FIG. 1A is sits flatly against a bottom face 8 of the housing 1. In the closed position, any torque that acts in the closing direction is transmitted directly from the hinge body 2 into the housing 1, without the rotationally movable parts of the hinge being loaded. The result is a stable closed position.

The sector gear 5 at the inner end of the hinge body 2 has the shape of a segment of an ellipse of which one semi-major axis 23 is oriented in the closed position perpendicular to the rack 6 on the inside of the housing. The rack 6 on the side wall of the housing 1 extends parallel to the door opening and perpendicular to the axis 3. The result of this elliptical shape of the sector gear 5 is that there is a significant rotational movement during movement from the closed position shown in FIG. 1A up to the intermediate position shown in FIG. 1B and only slight straight-line movement of the hinge axis 3 with a short stroke length x₁. As the rotational angle increases, there is progressively increasing straight-line displacement of the hinge axis 3. Comparing the functional positions shown in FIG. 1B and FIG. 1C it may be seen that doubling the rotational angle from 35° to 70° results in a straight-line displacement length or stroke x₂ of the hinge axis 3 that is more than twice the length of the stroke x₁. The hinge axis 3 migrates farther outward until the functional position shown in FIG. 1D is attained at the maximum opening angle of at least 100°. The elliptical shape of the sector gear 5 permits realization of a long outwardly oriented displacement path, coupled to the pivot movement, in a housing 1 that is distinguished by a relatively short depth.

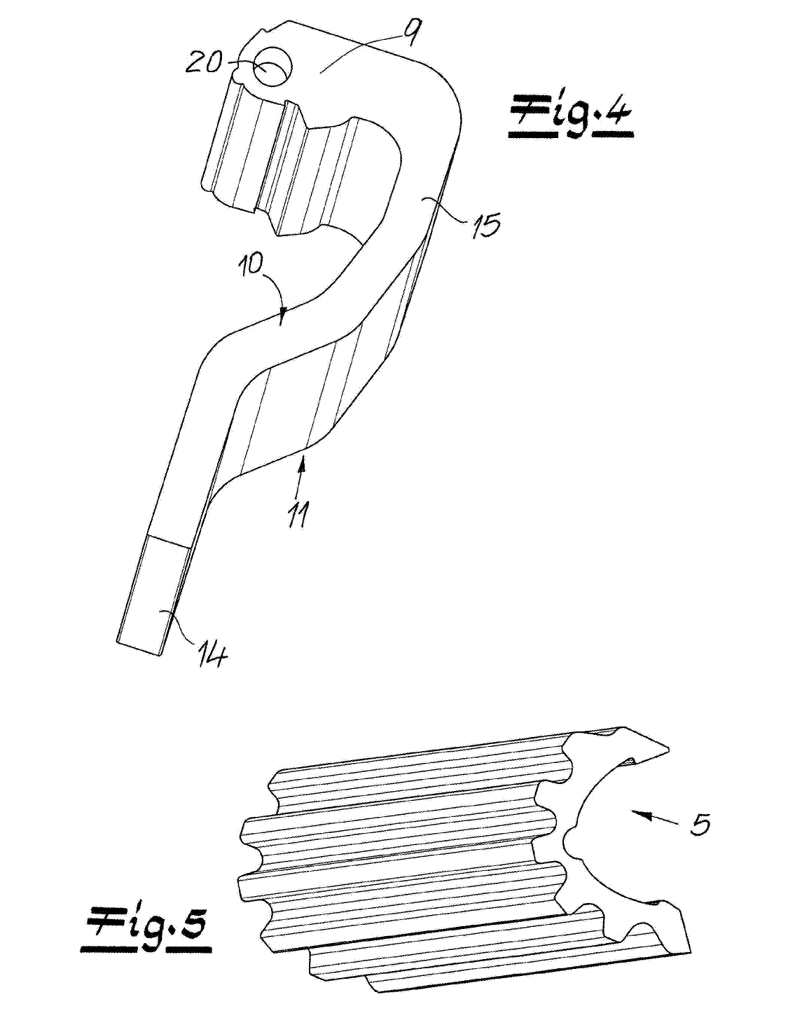

The sector gear 5 is made of plastic or another suitable material that dampens noise and permits the most maintenance-free movement possible. It may be seen from FIGS. 4 and 5 that the sector gear 5 comprises a separate plastic part that is attached or clipped to the inner end 9 of the a metal hinge body 2. The sector gear 5 and the hinge body 2 are joined to one another rotation-fast and in a positive fit. It is also within the scope of the invention that the sector gear 5 is permanently joined to the hinge body 2 by vulcanization.

The housing 1 is a cast metal part, and the rack 6 is molded unitarily with it. The rack 6 may alternatively comprise a pre-fabricated toothed profile that is attached to the housing 1 in a suitable manner.

The ends of the unillustrated pivot shaft in the bore 20 project as the square stubs 12 from an upper end face 10 of the hinge body 2 and a lower end face 11 of the hinge body 2. Respective upper and lower insert plates 13 fixed in the and forming part of the housing 1 are formed with the guide slots 4 in which these stubs 12 can slide parallel to the rack 6. Adjusting devices such as mounting bolts may be provided that permit a position adjustment in at least one axial direction relative to the housing 1 of the guide plates 13.

FIGS. 1A and 1D show that the hinge body 2, between the inner end 9 provided with the sector gear 5 and the projecting outer end 14 has an arcuate center part 15 that in the open position (FIG. 1D) surrounds an upper edge of the housing 1.

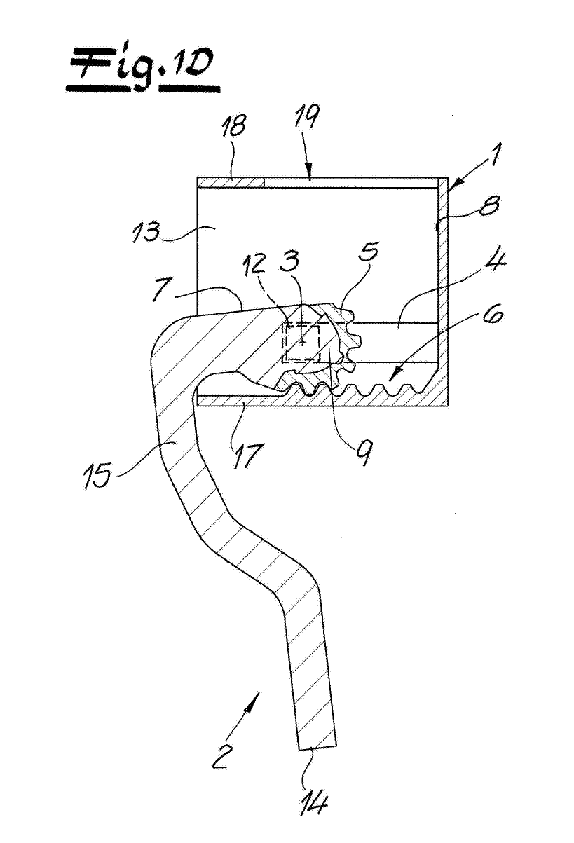

According to FIG. 3, the housing 1 has the two side walls 17 and 18 connected by a bottom and top end wall, the rack 6 being arranged on the side wall 17 and the second side wall 18 having an opening 19 into which the bent curved center piece 15 of the hinge body 2 dips when the hinge body 2 assumes the closed position shown in FIG. 1A. This results in a more compact structure of the hinge with a narrow housing 1.

We claim:

1. A door or window hinge comprising:
a housing having a back wall facing in a predetermined direction and a side wall extending in the direction from the back wall;
a guide in the housing extending in the direction a hinge body having an inner end in the housing and an outer end extending from the housing;
a rack fixed to the side wall and extending in the direction;
a sector gear fixed to the inner end, meshing with the rack, and formed as a partial ellipse having a semimajor axis or a parabola; and
structure supporting the inner end of the body in the housing for rotation about an axis perpendicular to the direction and slidable in the guide in the direction such that the hinge body can pivot about the axis relative to the housing and also move in a straight line in the direction along the guide relative to the housing between an inner closed position with the inner end bearing on the back wall and an open position with the inner end spaced in the direction from the back wall, the sector gear being oriented on the inner end such that in the closed position the semimajor axis extends substantially perpendicular to the direction.

2. The hinge defined in claim 1, wherein the direction is parallel to a plane of a door or window carried on the outer end of the hinge body.

3. The hinge defined in claim 1, wherein the sector gear is of plastic.

4. The hinge defined in claim 3, wherein the hinge body is of metal.

5. The hinge defined in claim 1, wherein the guide is a slot extending in the direction and the structure fits complementarily in and can slide in the direction in the slot.

6. The hinge defined in claim 4, wherein the housing has two of the guides flanking the inner end and the structure fits in both of the guides.

7. The hinge defined in claim 1, wherein the hinge body has an arcuate center part between the inner end and the outer end, the center part wrapping around the housing in the open position.

8. The hinge defined in claim 7, wherein the housing has, in addition to the first-mentioned side wall, a second side wall spaced therefrom, the second side wall being formed with a cutout in which the arcuate center pert. engages in the closed position.
